(19) United States
(12) Patent Application Publication
(10) Pub. No.: US 2025/0189932 A1
(43) Pub. Date: Jun. 12, 2025

(54) WATCH MOVEMENT COMPRISING MECHANISM FOR DISPLAYING THE PERIODS OF AN ANNUAL CYCLE MOVED IN JUMPS BY A DRIVE MOBILE WITH A 31-POSITION

(71) Applicant: Blancpain SA, Le Brassus (CH)

(72) Inventors: Bernat MONFERRER, St-Prex (CH); Vincent LE NOA, Bois D'Amont (FR)

(73) Assignee: Blancpain SA, Le Brassus (CH)

(21) Appl. No.: 18/971,244

(22) Filed: Dec. 6, 2024

(30) Foreign Application Priority Data
Dec. 8, 2023 (EP) 23215307.2

(51) Int. Cl. G04B 19/24; G04B 27/02

(52) U.S. Cl. CPC G04B 19/241; G04B 27/023

(57) ABSTRACT

A watch movement including a date mechanism including a drive mobile with 31 stable positions actuated in steps of one step per day by a time train; a mechanism for displaying the periods of an annual cycle driven in jumps by the drive mobile, the mechanism for displaying the periods of an annual cycle including a member for indicating the periods of an annual cycle and an annual cycle train moved directly by the drive mobile and configured to rotate the member for indicating annual cycle periods; the annual cycle train including an annual cycle drive wheel kinematically coupled in rotation with an annual cycle correction wheel, the annual cycle correction wheel being meshed with the member for indicating annual cycle periods; an annual cycle correction mechanism configured to correct the mechanism for displaying the periods of an annual cycle by rotating a winding stem rotating the annual cycle correction wheel and changing the indexing between the annual cycle drive wheel and the annual cycle correction wheel.

### TECHNICAL FIELD OF THE INVENTION

The field of the invention relates to timepiece mechanisms for displaying the periods of an annual cycle, for example the seasons, moved in jumps by a drive mobile with 31 stable positions.

The invention also relates to a mechanism for correcting a mechanism for displaying the periods of an annual cycle.

The invention also relates to a watch movement comprising a mechanism for displaying the periods of an annual cycle and a date mechanism.

The invention also relates to a timepiece, for example a wristwatch.

### TECHNOLOGICAL BACKGROUND

Mechanisms for displaying an annual cycle, and in particular the periods of this annual cycle, make it possible to display information relating to a given period during a solar annual cycle.

The mechanisms for displaying the periods of an annual cycle are generally mechanisms with a jumping drive enabling an indicator to be positioned opposite a graduation or division of a dial. An annual cycle can be divided into a number of periods corresponding to the graduations or divisions of the dial. However, these jump-type mechanisms for displaying the periods of an annual cycle are not very precise, as they cannot tell the user whether the period displayed is at the beginning or the end of the annual cycle.

For example, when such a mechanism for displaying the periods of an annual cycle makes it possible to indicate the months, or for example the seasons, the hand indicates the current period (months or seasons) but without displaying more precise information about the remaining time in the current period. As a result, the jumping drive in these displays produces a “display error” relative to the actual situation for the current period.

To remedy this disadvantage, document EP 0397028 provides an annual cycle display mechanism driven by a drive mobile with a 31-tooth wheel that engages directly with a date wheel. With a suitable gear ratio, the annual cycle display makes one turn for every 372 steps of the drive mobile. In other words, the annual cycle period display makes one turn for every twelve complete turns of the drive mobile, and the drive mobile, engaged with the date display, makes one complete turn per month.

With such a display mechanism, it has thus been possible to improve the display precision of such a jumping drive by driving the annual cycle display once a day instead of once a period.

However, such a date-driven annual cycle display mechanism is time-consuming to set, as it requires the user to make a maximum of 372 date corrections manually, which is considered unergonomic setting and leaves the user with the impression of a timepiece that is not very prestigious.

There is therefore a need to improve this jumping-type mechanism for displaying the periods of an annual cycle driven by a mobile with 31 stable positions of a date display, and in particular the mechanisms for correcting such a display mechanism in order to address at least one of the aforementioned problems.

### SUMMARY OF THE INVENTION

In this context, the invention proposes a watch movement comprising a mechanism for displaying the periods of an annual cycle moved in jumps by a drive mobile with 31 stable positions and actuated step by step each day, and comprising a rapid correction mechanism for independently correcting the display of the annual cycle via a pulled-out position on the winding stem of the watch movement.

The jump-driven mechanism for displaying the periods of an annual cycle also has improved display resolution that can be easily set by the user.

The invention relates more particularly to a watch movement comprising:
a winding stem that can assume at least two pulled-out positions relative to a neutral pressed-in position;
a date mechanism comprising a drive mobile with 31 stable positions actuated in steps of one step per day by a time train, the drive mobile with 31 stable positions moving a date indicator;
a mechanism for displaying the periods of an annual cycle moved in jumps by the drive mobile with 31 stable positions, said mechanism for displaying the periods of an annual cycle comprising a member for indicating annual cycle periods and an annual cycle train moved directly by the drive mobile with 31 stable positions and configured to rotate the member for indicating annual cycle periods at each step of the drive mobile with 31 stable positions; the annual cycle train comprising an annual cycle drive wheel kinematically coupled in rotation with an annual cycle correction wheel, the annual cycle correction wheel being meshed with the member for indicating annual cycle periods;
an annual cycle correction mechanism configured to rapidly and independently correct the mechanism for displaying the periods of an annual cycle when the winding stem is rotated in a first pulled-out position; the annual cycle correction mechanism being configured such that rotating the winding stem rotates the annual cycle correction wheel and changes the indexing between the annual cycle drive wheel and the annual cycle correction wheel as it moves beyond the existing couple between the annual cycle drive wheel and the annual cycle correction wheel.

According to the invention, the mechanism for displaying the periods of an annual cycle can be a mechanism for displaying the months, the weeks, the constellations, the zodiac signs, an equation of time, a running equation of time, the Christian holidays, the equinoxes and solstices, the climatic seasons, the inclination of the earth relative to the sun, the Chinese seasons or even the sidereal periods.

Preferentially, the mechanism for displaying the periods of an annual cycle is a mechanism for displaying the sidereal periods.

Preferentially, the mechanism for displaying the periods of an annual cycle is mechanism for displaying the Chinese seasons.

In addition to the characteristics mentioned in the previous paragraph, the watch movement according to the invention can have one or more complementary characteristics from among the following, taken individually or in any technically possible combination:
the annual cycle drive wheel is kinematically coupled in rotation with the annual cycle correction wheel by way of a correction star cooperating with a correction jumper configured to ensure that the correction star is kept in a stable position when the watch movement is running normally;
the correction star is integral in rotation with the annual cycle correction wheel and the correction jumper is carried by the annual cycle drive wheel or in that the correction star is integral in rotation with the annual cycle drive wheel and the correction jumper is carried by the annual cycle correction wheel;
the correction star comprises 6 branches;
correcting the member for indicating annual cycle periods using the winding stem changes the indexing between the annual cycle drive wheel and the annual cycle correction wheel in jumps, such that the member for indicating annual cycle periods is corrected in 30° jumps;
the gear ratio of the resulting annual cycle train between the drive mobile with 31 stable positions and the member for indicating annual cycle periods is 12, such that the member for indicating annual cycle periods makes one complete turn after twelve complete turns of the drive mobile with 31 stable positions;
the mechanism for displaying the periods of an annual cycle is mechanism for displaying the seasons, preferentially the Chinese seasons;
the member for indicating annual cycle periods comprises an annual cycle display wheel carrying an annual cycle period indicator, the annual cycle display wheel being meshed with the annual cycle correction wheel;
the date mechanism comprises a 24-hour wheel moved by the time train, said 24-hour wheel comprising a finger configured to move a date lever once a day, actuating the drive mobile with 31 stable positions by one step;
the watch movement comprises a date correction member configured to act on said date lever and to actuate the drive mobile with 31 stable positions by one step each time the date correction member is acted upon.

The invention also relates to a timepiece comprising a watch movement according to the invention.

Advantageously, the timepiece is a wristwatch.

### BRIEF DESCRIPTION OF THE FIGURES

The purposes, advantages and characteristics of the present invention will become apparent from the detailed description below in reference to the following figures:

FIG. 1 schematically illustrates a top view of a watch movement according to the invention comprising a date mechanism and a mechanism for displaying the periods of an annual cycle driven in jumps by a 31-position drive mobile of the date mechanism;

FIG. 2 schematically illustrates a view from underneath the watch movement shown in FIG. 1;

FIG. 3 illustrates a synoptic diagram of the watch movement 1 according to the invention;

FIG. 4 is a schematic representation of a timepiece comprising the watch movement according to the invention.

In all of the figures, common elements have the same reference numbers unless otherwise specified.

### DETAILED DESCRIPTION OF THE INVENTION

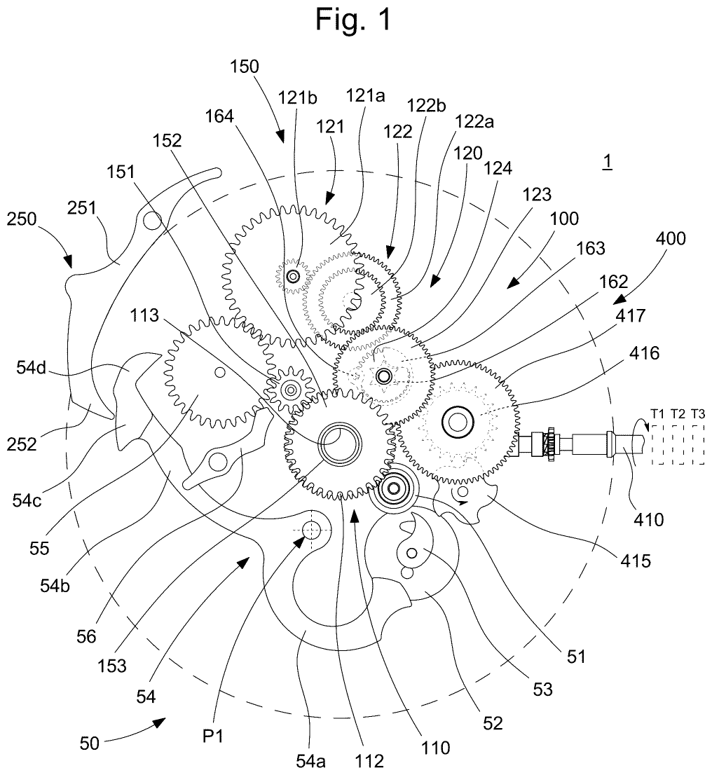

FIG. 1 schematically illustrates a top view of a watch movement 1 according to the invention comprising a date mechanism 50 and a mechanism for displaying the periods of an annual cycle 100 driven in jumps by a 31-position drive mobile 55 of the date mechanism 50.

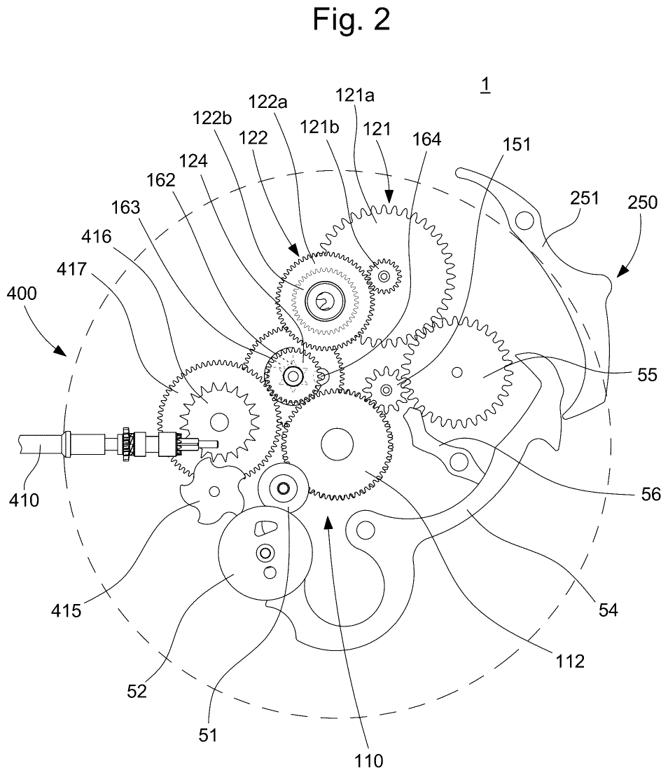

FIG. 2 schematically illustrates a view from underneath the watch movement 1 shown in FIG. 1.

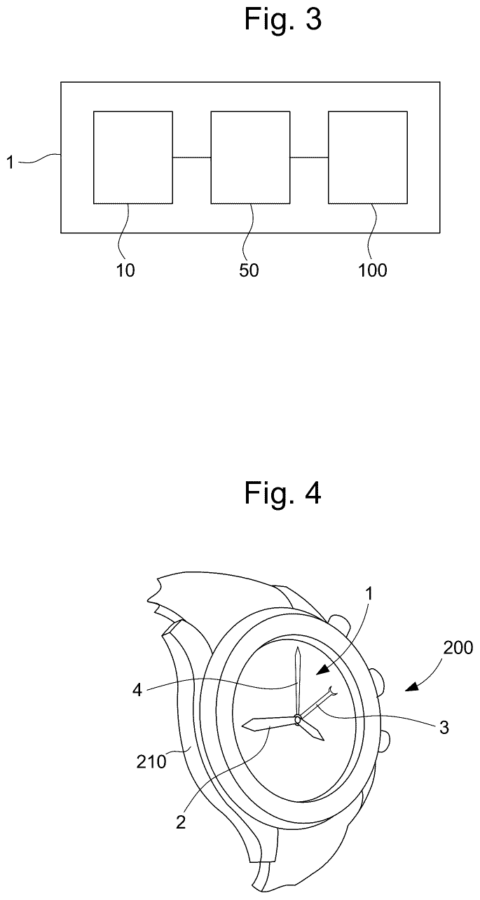

FIG. 3 is a synoptic diagram of the watch movement 1 according to the invention.

FIG. 4 schematically illustrates a timepiece 200 comprising a case 210 housing the watch movement 1 according to the invention. For example, the timepiece 200 is a wristwatch.

The watch movement 1 typically comprises a time train 10, shown in part, that has in particular a minute mobile driving an hour wheel, the time train assembly being configured so that the hour wheel makes one complete turn in 12 hours.

The hour wheel typically carries an hour indicator, for example an hour hand 2 (visible in FIG. 4) driven on the arbor of the hour wheel.

The watch movement 1 according to the invention comprises a date mechanism 50 kinematically connected to the time train 10.

The date mechanism 50 typically comprises a 24-hour wheel 52 kinematically connected to the hour wheel of the time train 10, for example via an intermediate mobile 51 as shown in FIGS. 1 and 2.

The 24-hour wheel 52 carries a finger 53 configured to cooperate with a date lever 54 and to move it once a day, at each turn of the 24-hour wheel 52.

The date lever 54 comprises a first arm 54a and a second arm 54b extending on either side of a pivot axis P1. The date lever 54 is actuated by a spring (not shown) that moves the first arm 54a towards the finger 53.

The end of the second arm 54b comprises a lever head 54c ending in a lever beak 54d configured to cooperate with the toothing of the 31-position drive mobile 55 of the date mechanism 50.

Thus, once a day, the finger 53 moves the date lever 54 when it comes into contact with the end of the first arm 54a. Under the pressure of the finger 53, the date lever 54 pivots around its pivot axis P1 such that it brings the lever beak 54d into contact with the toothing of the 31-position drive mobile 55 and rotates it by one step.

At each step, the 31-position drive mobile 55 is kept in a stable position by a date jumper 56 and a date jumper (not shown) configured to push the date jumper 56 back towards the toothing of the 31-position drive mobile 55.

The 31-position drive mobile 55 is meshed with a date train 150 comprising, for example, an intermediate mobile 151 and a date display wheel 152 with an arbor 153 suitable for receiving, for example, a date hand 3 forming a date indicator (visible in FIG. 4). The date indicator 3 can also have other forms.

The date mechanism 50 also comprises a date correction member 250, for example a pusher, acting on a correction lever 251 comprising at one end a correction beak 252 configured to set the date lever 54 in motion each time the date correction member 250 is acted upon. More specifically, the correction beak 252 presses against the lever head 54c so as to actuate the 31-position drive mobile 55 by one step via the lever beak 54d which acts on the toothing of the 31-position drive mobile 55. Thus, each time the date correction member 250 is acted upon, the 31-position drive mobile 55 and accordingly the date hand 3 can be corrected by one step.

The watch movement 1 also comprises a mechanism for displaying the periods of an annual cycle 100 moved in jumps by the date mechanism 50, and more particularly by the 31-position drive mobile 55 of the date mechanism 50.

The mechanism for displaying the periods of an annual cycle 100 can be a mechanism for displaying the months, the weeks, the constellations, the zodiac signs, an equation of time, a running equation of time, the Christian holidays, the equinoxes and solstices, the climatic seasons, the inclination of the earth relative to the sun, the Chinese seasons or even the sidereal periods.

Preferentially, the mechanism for displaying the periods of an annual cycle 100 is a mechanism for displaying the months, the seasons or even the Chinese seasons.

The mechanism for displaying the periods of an annual cycle 100 comprises a member for indicating annual cycle periods 110.

In the illustrated exemplary embodiment, the member for indicating annual cycle periods 110 comprises an annual cycle display wheel 112 (visible more specifically in FIG. 2) with an arbor 113 suitable for receiving, for example, a hand 4 forming an annual cycle period indicator (visible in FIG. 4).

According to a variant embodiment, the annual cycle display wheel 112 can rotate a disc that has indications, indexes or graduations on its upper face corresponding to the periods of the annual cycle to be displayed.

Depending on the desired type of display, the disc can be visible in full or in part through a suitably-shaped opening in a dial of the timepiece 200.

When the watch movement 1 is running normally, the member for indicating annual cycle periods 110 is driven by an annual cycle train 120 moved directly by the 31-position drive mobile 55.

In the example shown, the 31-position drive mobile 55 meshes with a wheel 121a of a first intermediate mobile 121. The first intermediate mobile 121 comprises a pinion 121b that meshes with a wheel 122a of a second intermediate mobile 122. The second intermediate mobile 122 comprises a pinion 122b that meshes with an annual cycle drive wheel 123.

The annual cycle drive wheel 123 is kinematically coupled in rotation with an annual cycle correction wheel 124, coaxial to the annual cycle drive wheel 123, and which meshes with the annual cycle display wheel 112 carrying the annual cycle period indicator 4.

According to the invention, the annual cycle drive wheel 123 is coupled in rotation with the annual cycle correction wheel 124 by a correction star 162 positioned between the two wheels 123, 124. The correction star 162 cooperates with a correction jumper 163 associated with its spring (not shown), the correction jumper 163 being configured to ensure that the correction star 162 is kept in a stable position when the watch movement 1 is running normally. The correction star 162 and the correction jumper 163 thus form a coupling device whose indexing between the two wheels 123, 124 can be changed by an annual cycle correction mechanism 400 which will be described below.

According to the exemplary embodiment shown, the correction star 162 is integral in rotation with the annual cycle correction wheel 124 and the correction jumper 163 is carried by the annual cycle drive wheel 123, for example via a pin 164. Of course, the correction jumper 163 is mobile in rotation around this pin 164, which forms a pivot axis for the correction jumper 163, so that it can cooperate with the various branches of the correction star 162.

According to an alternative embodiment, the correction jumper 163 is a deflection jumper spring, configured to enable changes to be made to the indexing between the annual cycle drive wheel 123 and the annual cycle correction wheel 124, while ensuring that the correction star 162 is kept in a stable position when the watch movement 1 is running normally.

In a variant embodiment, the correction star 162 can be integral with the annual cycle display wheel 123 and the correction jumper 163 can be carried by the annual cycle correction wheel 124.

Thus, when the watch movement 1 is running normally, the rotation of the annual cycle drive wheel 123, driven by the rotation of the 31-position drive mobile 55, rotates the annual cycle correction wheel 124 which is coupled in rotation with the annual cycle drive wheel 123. The annual cycle correction wheel 124 in turn drives the annual cycle display wheel 112 carrying the annual cycle period indicator 4.

Preferentially, the gear ratio of the resulting annual cycle train 120 between the 31-position drive mobile 55 and the member for indicating annual cycle periods 110 is 12, meaning that the member for indicating annual cycle periods 110 will make one complete turn after 12 months and thus 372 jumps of the 31-position drive mobile 55 and the date hand 3 (in other words, 12×31 jumps).

Thus, according to the example shown, the annual cycle period indicator 4 is driven each day by the 31-position drive mobile 55, with jumps of 0.9677° per day.

The watch movement 1 also comprises an annual cycle correction mechanism 400 enabling the angular position of the annual cycle display wheel 112 to be corrected, independently of the date, by rotating a winding stem 410 around its rotational axis, in a given axial position of the winding stem 410.

Typically, the winding stem 410 can be moved axially along its rotational axis between different axial positions corresponding to different functions of the watch movement 1, such as manually winding the movement, setting the time, setting the date and/or setting other indicators.

For example, the winding stem 410 has a first axial position T1 which is a neutral pressed-in position corresponding to the winding position of the watch movement 1, enabling the barrel spring to be wound. In this first axial position T1, the winding stem 410 is fully pushed towards the case 210 of the timepiece 200.

For example, the winding stem 410 has a second axial position T2 which is a first pulled-out position relative to the neutral pressed-in position and which corresponds to a position for setting the annual cycle display wheel 112.

For example, the winding stem 410 has a third axial position T3 which is a second pulled-out position relative to the neutral pressed-in position and which corresponds to a position for setting the watch movement 1, for example a position for setting the time.

To reach the second axial position T2, the user pulls axially on the crown of the winding stem 410, from the neutral position T1, to move it axially towards the outside of the case 210 of the timepiece 200.

To reach the third axial position T3, the user pulls axially on the crown of the winding stem 410, from the second axial position T2, to move it axially towards the outside of the case 210 of the timepiece 200.

FIG. 1 schematically shows the position of the crown of the winding stem 410 in the various axial positions T1, T2, T3 of the winding stem 410.

Of course, the winding stem 410 can comprise other pulled-out positions depending on the needs and complexities of the watch movement 1.

In this second axial position T2, the sliding pinion of the winding stem 410, which has reverse axial displacements to those of the winding stem 410 along the rotational axis, is moved into engagement with a train of intermediate wheels (not shown) configured to mesh with a corrector 415 comprising at least one actuating finger.

In the exemplary embodiment shown, the corrector 415 comprises 5 fingers evenly distributed around the edge of the corrector 415, such that the annual cycle can be corrected more quickly by rotating the winding stem 410.

The corrector 415 is configured to cooperate with the toothing of an annual cycle corrector star 416 that is integral in rotation with an intermediate annual cycle correction wheel 417.

The corrector 415 is mounted on a sliding-gear assembly, such that rotating the winding stem 410 in a predetermined rotational direction, for example clockwise, enables the corrector 415 to be brought into engagement with the toothing of the annual cycle corrector star 416 and the corrector 415 to be rotated, for example counter-clockwise.

The intermediate annual cycle correction wheel 417 is meshed with the annual cycle correction wheel 124. Thus, rotating the winding stem 410 enables the annual cycle correction wheel 124 to be rotated by changing its indexing between the annual cycle drive wheel 123 as it moves beyond the coupling force generated by the correction jumper 163, and its spring, cooperating between two consecutive teeth of the correction star 162.

The winding stem 410 makes it possible to quickly correct the member for indicating annual cycle periods 110, for example by jumps corresponding to a period of one month or 31 date jumps, for example by 30° jumps of the member for indicating annual cycle periods 110 when the dial comprises 12 indexes divided over 360°.

The watch mechanism 1 works as follows: when the timepiece 200 is running normally, the 31-position drive mobile 55 is driven one step per day by the time train 10 as indicated above via the finger 53 acting on the date lever 54.

The 31-position drive mobile 55 rotates the intermediate mobile 151 and the date display wheel 152 carrying the date indicator 3 by one step per day.

The 31-position drive mobile 55 also rotates the first intermediate mobile 121 of the annual cycle train 120. The first intermediate mobile 121 in turn drives the second intermediate mobile 122 of the annual cycle train 120 that meshes with the annual cycle drive wheel 123. With no particular action on the annual cycle correction mechanism 400 and the winding stem 410, the annual cycle drive wheel 123 is coupled to the annual cycle correction wheel 124, such that rotating the annual cycle drive wheel 123 rotates the annual cycle display wheel 112 and the annual cycle indicator 4 by one step per day, or 0.9677°.

If the date indicator 3 needs to be corrected, the user uses the date correction member 250. Whenever the date correction member 250 is acted upon, the date lever 54 is actuated such that it acts on the 31-position drive mobile 55, which is driven by one step.

If the member for indicating annual cycle periods 110 needs to be corrected, the user positions the winding stem 410 in the corresponding axial position, which is the second axial position T2 in the exemplary embodiment described, positioned between the winding position T1 and the time-setting position T3.

When the winding stem 410 is in this position, the sliding pinion of the winding stem 410 is brought into engagement with the intermediate correction wheel in the train of intermediate wheels. When the user rotates the winding stem 410 in a predetermined rotational direction, the intermediate correction wheel is driven, which in turn drives a train of intermediate wheels until the corrector 415 is rotated.

Rotating the corrector 415 rotates the annual cycle corrector star 416 and therefore the intermediate annual cycle correction wheel 417, integral in rotation with the annual cycle corrector star 416.

The intermediate annual cycle correction wheel 417 meshes with the annual cycle correction wheel 124.

Thus, rotating the annual cycle correction wheel 124 rotates the annual cycle display wheel 112 as it moves beyond the indexing couple formed by the cooperation of the correction star 162 and the correction jumper 163 to change the relative position of the annual cycle correction wheel 124 relative to the annual cycle drive wheel 123 in engagement with the annual cycle train 120 and the 31-position drive mobile 55.

In the exemplary embodiment shown, the correction star 162 comprises 6 branches and the gear ratio between the annual cycle correction wheel 124 and the annual cycle display wheel 112 is 1/2. Thus, the annual cycle display wheel 112 is corrected in jumps as it rotates through an angle of 30°, which is equivalent to a correction of one month, or 31 steps of the 31-position drive mobile 55. This is made possible by the ratio of 1/2 between the annual cycle display wheel 112 and the annual cycle correction wheel 124, since each jump in the 6-branched correction star 162 corresponds to a 60° rotation of the correction star 162, and accordingly of the annual cycle correction wheel 124.

Of course, the correction star 162 can comprise a different number of branches; the gear ratio between the annual cycle correction wheel 124 and the annual cycle display wheel 112 will have to be adapted according to the above ratios and to the number of branches of the correction star 162 so that the annual cycle display wheel 112 is corrected by jumps of 30°, when the dial is divided into 12 annual cycle periods.

Other constructions are possible without departing from the scope of the invention.

There are thus two ways of correcting the member for indicating annual cycle periods 110: either by correcting the 31-position drive mobile 55 in steps via the date correction member 250, or more quickly by rotating the winding stem 410 in a predetermined rotational direction.

The watch mechanism 1 according to the invention offers several advantages. Since the mechanism for displaying the periods of an annual cycle 100 is indexed to the date mechanism 50, if the date mechanism is kept up to date, for example by making the relevant corrections in the shorter months, the annual cycle period display will never lag and will always be indexed to the date.

Such a mechanism is therefore particularly precise compared with mechanisms for displaying the periods of an annual cycle that are not connected to a date mechanism or to a date drive mobile with 31 stable positions.

1. A watch movement comprising:
a winding stem that can assume at least two pulled-out positions relative to a neutral pressed-in position;
a date mechanism comprising a drive mobile with 31 stable positions actuated in steps of one step per day by a time train, the drive mobile with 31 stable positions moving a date indicator;
a mechanism for displaying the periods of an annual cycle moved in jumps by the drive mobile with 31 stable positions, said mechanism for displaying the periods of an annual cycle comprising a member for indicating annual cycle periods and an annual cycle train moved directly by the drive mobile with 31 stable positions and configured to rotate the member for indicating annual cycle periods at each step of the drive mobile with 31 stable positions; the annual cycle train comprising an annual cycle drive wheel kinematically coupled in rotation with an annual cycle correction wheel, the annual cycle correction wheel being meshed with the member for indicating annual cycle periods;
an annual cycle correction mechanism configured to rapidly and independently correct the mechanism for displaying the periods of an annual cycle when the winding stem is rotated in a first pulled-out position; the correction mechanism being configured such that rotating the winding stem rotates the annual cycle correction wheel and changes the indexing between the annual cycle drive wheel and the annual cycle correction wheel as it moves beyond the existing couple between the annual cycle drive wheel and the annual cycle correction wheel.

2. The watch movement according to claim 1, wherein said annual cycle drive wheel is kinematically coupled in rotation with the annual cycle correction wheel by way of a correction star cooperating with a correction jumper configured to ensure that the correction star is kept in a stable position when the watch movement is running normally.

3. The watch movement according to claim 2, wherein said correction star is integral in rotation with the annual cycle correction wheel, and the correction jumper is carried by the annual cycle drive wheel or wherein said correction star is integral in rotation with the annual cycle drive wheel, and the correction jumper is carried by the annual cycle correction wheel.

4. The watch movement according to claim 2, wherein said correction star comprises 6 branches.

5. The watch movement according to claim 1, wherein correcting the member for indicating annual cycle periods using the winding stem changes the indexing between the annual cycle drive wheel and the annual cycle correction wheel in jumps, such that the member for indicating annual cycle periods is corrected in 30° jumps.

6. The watch movement according to claim 1, wherein a gear ratio of the resulting annual cycle train between the drive mobile with 31 stable positions and the member for indicating annual cycle periods is 12, such that the member for indicating annual cycle periods makes one complete turn after twelve complete turns of the drive mobile with 31 stable positions.

7. The watch movement according to claim 1, wherein said mechanism for displaying the periods of an annual cycle is a mechanism for displaying the seasons, preferably the Chinese seasons.

8. The watch movement according to claim 1, wherein said member for indicating annual cycle periods comprises an annual cycle display wheel carrying an annual cycle period indicator, the annual cycle display wheel being meshed with the annual cycle correction wheel.

9. The watch movement according to claim 1, wherein said date mechanism comprises a 24-hour wheel moved by the time train, said 24-hour wheel comprising a finger configured to actuate, once a day, a date lever moving the drive mobile with 31 stable positions by one step.

10. The watch movement according to claim 9, wherein said watch movement comprises a date correction member configured to act on said date lever and to actuate the drive mobile with 31 stable positions by one step each time the date correction member is acted upon.

11. A timepiece comprising a watch movement according to claim 1.

12. The timepiece according to claim 11, wherein said timepiece is a wristwatch.
